(19) United States
(12) Patent Application Publication
(10) Pub. No.: US 2002/0065637 A1
(43) Pub. Date: May 30, 2002

(54) Method and apparatus for simulating the measurement of a part without using a physical measurement system

(76) Inventors: John S. Thompson, Haslemere (GB); Andrew M. Bird, Richmond (GB)

Correspondence Address: Gary S. Engelson, c/o Wolf, Greenfield & Sacks, P.C., Federal Reserve Plaza, 600 Atlantic Avenue, Boston, MA, 02210-2211, US

(21) Appl. No.: 09/727,390

(22) Filed: Nov. 30, 2000

(51) Int. Cl. G06F 9/45

(52) U.S. Cl. 703/6

(57) ABSTRACT

A method and apparatus simulate measuring a part by loading measurement software and a software model of the part into a computer and processing the model through a virtual measurement instrument to produce inputs to the measurement software. By using the method and apparatus, a measurement program can be developed for a part without needing a physical instance of the part or a real measurement system.

### BACKGROUND

1. Field of the Invention

The present invention relates generally to programming of mechanical inspection systems for measuring manufactured parts. More particularly, the present invention relates to computer software for simulating measurements produced by a measurement environment, for the purpose of creating such inspection programs.

2. Related Art

In machine vision and non-contact metrology applications, two-dimensional (2D) video camera images and 2D images from other electronic imaging devices are used to detect and/or measure features of real physical parts placed in the optical path of the system. Such systems generally include a control computer and a measurement frame including components for manipulating a part and taking measurements under direction of the control computer.

A great variety of image analysis algorithms are used to automatically extract information about the desired features from these 2D images. In order to be sure that an automatic sequence of positioning, measurement and processing steps, referred to hereinafter as an automatic inspection program, will measure correctly the desired feature in the image, typically it is necessary to pre-configure each step of the automatic inspection program manually using visual feedback, for at least one initial sample component. Typically, the automatic inspection program, which executes in the control computer along with the image analysis algorithm, has a configuration mode which allows an operator to adjust the various positioning, illumination, optical and image analysis parameters. The automatic inspection program then will test run the automatic inspection program to operate the measurement head and control computer and allow such operator adjustment until all steps in the program correctly process the desired features.

Conventionally this time consuming process of adjusting all the image analysis and control parameters can only be carried out on a complete measuring system. This system will typically consist of a non-contact measuring machine frame with optics, accurate motion control for precise component positioning under the optics (if necessary), electronic camera/imaging device, illumination control, and a computer system with suitable software to control the complete inspection system. Since the time consuming automatic inspection program preparation procedure requires working time on a complete measuring machine system, the system cannot be used for other production measurement and inspection work whilst a new inspection program is being prepared and tested ready for future use. The conventional programming method described is referred to as on-line programming because the equipment used for programming is on-line for actual use.

Contact metrology applications, sometimes called tactile metrology applications, employ a similar, though somewhat simpler process of manually programming an automatic inspection program. As with machine vision and non-contact metrology applications, a relatively time consuming on-line procedure consumes working time on a complete measuring machine system, preventing the system from use for other production measurement and inspection work.

### SUMMARY OF THE INVENTION

Therefore, it is a general object of the invention to provide an improved method and apparatus for preparing automatic inspection programs for machine vision, non-contact and contact metrology applications. Since the cost of the control computer system and software can be kept low compared to the total cost of a complete metrology system, this inventor has found that automatic inspection programs can be advantageously produced using only a computer system and inspection software, without the measuring machine frame and associated hardware.

According to one aspect of the invention, there is an apparatus for simulating the measurement of a part using a visual measurement system. The apparatus comprises a computer executing a software program which receives a digital model of a part, and renders an image of the model of the part, the image rendered under conditions simulating a measurement system, and which evaluates the image to produce a value representative of a physical characteristic of the part.

According to another aspect of the invention, there is a method of simulating measurement of a physical part using a computer model of the physical part. The method comprises launching measurement software, simulating a physical measurement system, manipulating the simulated measurement system to produce a virtual observation of the computer model, and analyzing the virtual observation to produce the simulated measurement.

According to yet another aspect of the invention, a software product includes a machine readable medium on which is encoded a sequence of instructions directing performance of the above method.

### BRIEF DESCRIPTION OF THE DRAWINGS

In the drawings in which like reference designations indicate like elements:

FIG. 1 is a flow chart of a method according to the present invention; and

FIGS. 2-18 are screen shots illustrating operation of an embodiment of the invention.

### DETAILED DESCRIPTION

The present invention is now illustrated by the following description of some embodiments and aspect thereof, which should be read in conjunction with the figures.

Before describing the illustrative embodiment in detail, some definitions will be useful.

An illustrative embodiment of the invention is constructed and operates entirely within a data processing system, computer or computer network. A conventional personal computer (PC) with an Intel Pentium processor, a Motorala 68XXX processor, a more advanced processor, or the like, running the Microsoft Windows operating system, the Mac OS, Unix, or the like can be used. Memory, program storage space, program storage media, such as hard disks, floppy disks, CD ROMs, etc., peripherals and input/output (I/O) devices can be selected by the skilled designer. It should be understood that references to computer systems should be read in a broad, conventional sense to include such PCs, as well as computers of other sizes and capacities, distributed computing environments, computer networks and the like. Computers also need not be based on electronic technology, but could be based on optical or other computing technologies for processing digital and analog signals representing physical phenomena.

The invention may also be embodied in a software product including a machine readable medium, such as a CD ROM, diskette, etc., encoded with a sequence of software instructions which when executed cause a data processing system, computer or computer network or the like to perform a method such as described below.

In the context of this application, a model is a representation of physical phenomena or characteristics as a signal or signals, analog or digital, in the computing technology used. The exemplary embodiment uses digital computing technology exemplified by the PC. A digital model is a representation of physical phenomena or characteristics, for example, those defining a part for manufacture, as digital data or software code from which the phenomena or characteristics can be derived. For example, a digital model produced by Computer Aided Design (CAD) software may define a part for manufacture in terms of shape, texture, color, etc. in three-dimensions (3D).

When a part is observed by a sensor, the sensor, perhaps in conjunction with other components of a measurement system, produces a representation of observed physical phenomena or characteristics referred to herein as an image. If the sensor is of an optical type, the image may be a visual representation of the part. However, an image is not limited to a visual representation. The image may represent the 3D coordinates at which contact was made by a tactile measurement sensor.

In the illustrative embodiment, a simulated measurement system is used in place of a real measurement system having a sensor. A simulated measurement system is a software program, program module or sequence of instructions which processes a model, for example a digital model, into an image of the model according to a translation or mapping which produces an image similar to that which would be produced by a corresponding real measurement system. Sometimes, an image of a model or a portion of such an image will be referred to as a virtual observation.

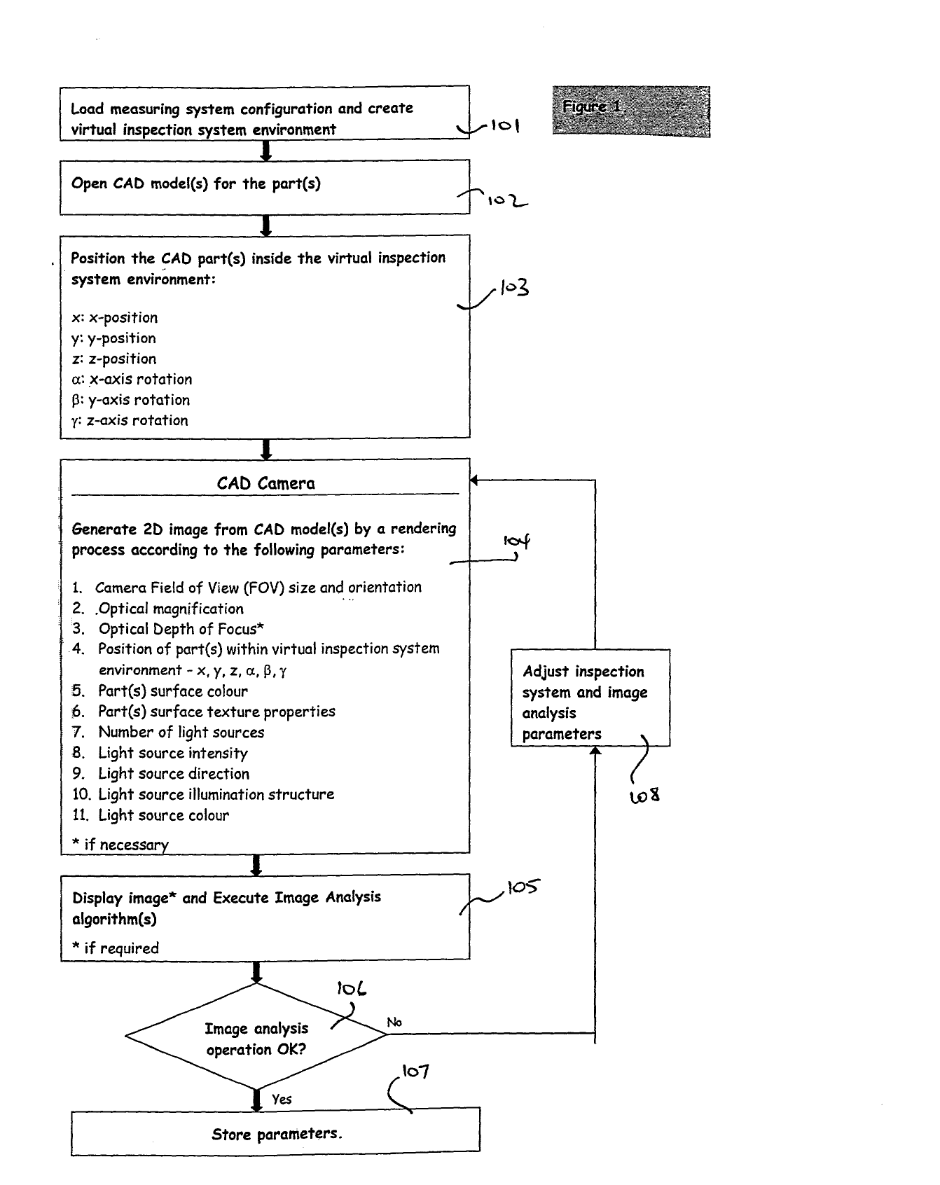

As shown in the flowchart of FIG. 1, a method embodying aspects of the invention proceeds as follows.

First, the simulated measurement system is loaded and executed by a suitable computer system. The simulated measurement system includes both conventional measurement software, that is, software normally used by a real measurement system, and software which simulates the measurement frame hardware of a real measurement system. This special software simulation capability is integrated into Xact Measure and Xact Vision metrology software from Brown & Sharpe Information Systems, Inc. The portions of Xact Measure and Xact Vision that provide the simulation capability could alternately be integrated with correctional measurement software PC-DMIS from Brown & Sharpe, Inc. and Quadra-Check from Metronics, Inc. Simulation of the measurement frame hardware is performed by a layer of software referred to as a virtual measuring instrument (VMI). The VMI may be implemented as a device driver in a Microsoft Windows environment. Operation of the VMI is discussed in further detail, below.

Next, a model of a part to be measured is loaded into the simulated measurement system. The illustrative embodiment supports a variety of CAD file formats in which the model may be represented, including, but not limited to, DWG, DXF, SAT, IGES, VDA/FS, STEP, CATIA, UG, Parasolids, Pro/E, IDEAS CAD, etc. formats corresponding to several popular CAD programs. The model should be a 3D model. If the measurement frame simulated by the VMI is a vision measurement system, for example employing a camera to capture information, the CAD model of the part should include fully modeled surfaces.

In order to provide greater realism, simulations of part anomalies could be included in the model loaded. Several techniques for accomplishing this are possible. For example, anomalies could be introduced by post processing the model after it has been constructed using conventional CAD software or using special purpose software designed for this use. The post processing could be done either before or after loading the model into the simulated measurement system. If the post processing is performed after loading the model into the simulated measurement system, individual features of the model can be selected, into which the anomalies are exclusively introduced.

Parameters within the VMI are adjusted to simulate a particular desired spatial relationship between the modeled part and the simulated measurement system. The spatial relationship may be fully specified, relative to a fixed datum established in the model, in terms of x, y and z position, as well as α, β and γ rotations of the simulated measurement system, relative to the datum.

An image of the modeled part is rendered, taking into account the spatial relationship established, as well as such other parameters as may be required. If a vision measurement system is being simulated by the VMI, then some of the parameters upon which the rendering depends include the camera field of view, lens optical magnification, the optical depth of focus, the surface color of the part modeled, the surface texture of the part modeled, the number of light sources, and the intensity, direction, illumination structure and color of the light sources.

In the case of a vision measurement system, the image produced is a conventional visual image of the part, which can be displayed to an operator, if desired. The image is analyzed, and if found to be satisfactory, then the parameters under which that image was produced are stored as correct for the particular desired measurement. If the image analysis finds the image to be unsatisfactory, then the parameters of the simulated measurement system are adjusted and a new image produced. The process of producing images and adjusting the parameters continues until a satisfactory image is produced. The image analysis portion of this process may be fully automated, based upon an objective criterion, such as satisfactory edge detection, etc., or may require operator feedback based upon a displayed image of the model of the part.

If the simulated measurement system is a tactile measurement system, the process proceeds substantially similarly. In this case, the VMI simulates both gross movement and probing speeds of the sensor head. The VMI also checks for unexpected collisions between parts of the simulated sensor and the modeled part or other objects. A VMI for a tactile measurement system can simulate changing probes, changing styli and use of motorized styli, as well. In such a system, the image produced may be a set of coordinates at which contact occurs when certain position commands are executed. A visual image based on measured coordinates and information known about a modeled part could be constructed and displayed, if desired.

Regardless of the type of measurement system simulated by the VMI, the image analysis includes the production of actual measurements of the model of the part. The image produced by the VMI is of the same type and format as that expected by the conventional measuring system software loaded at the beginning of the process. The image is therefore simply fed to the measurement system software, which produces a measurement.

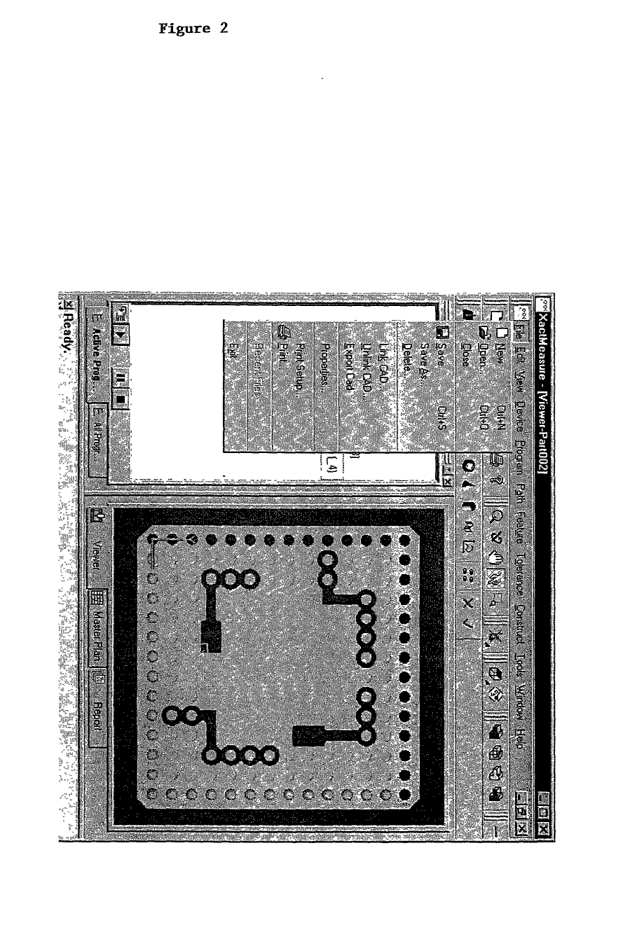

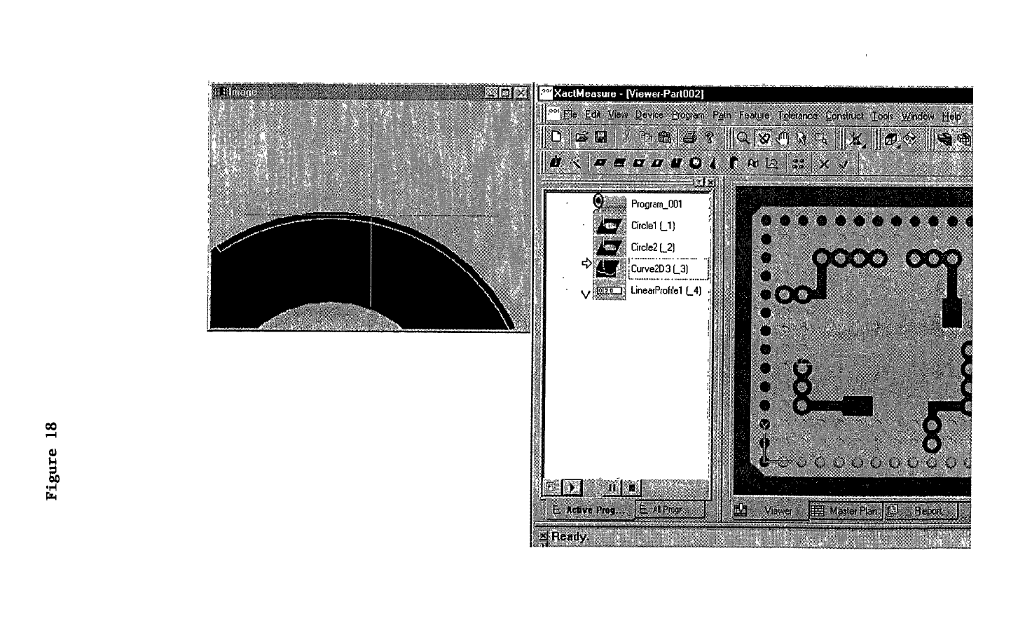

The process described above is now further illustrated in connection with some specific examples of the operation of the illustrative embodiment. The examples are illustrated by the screen shots of FIGS. 2-18.

As shown in FIG. 2, the operator runs the measurement software, in this example, Xact Measure, and loads a CAD file containing a software model with information about the structure in three dimensions of a part for which an inspection program is desired. The CAD model is displayed in a window similar to that used by a CAD program. While the window shown in FIG. 2 is displayed, the operator selects the relative positions of the part and the measurement system, so that further observation parameters can be set based on renderings of the view which the measurement system obtains of the part.

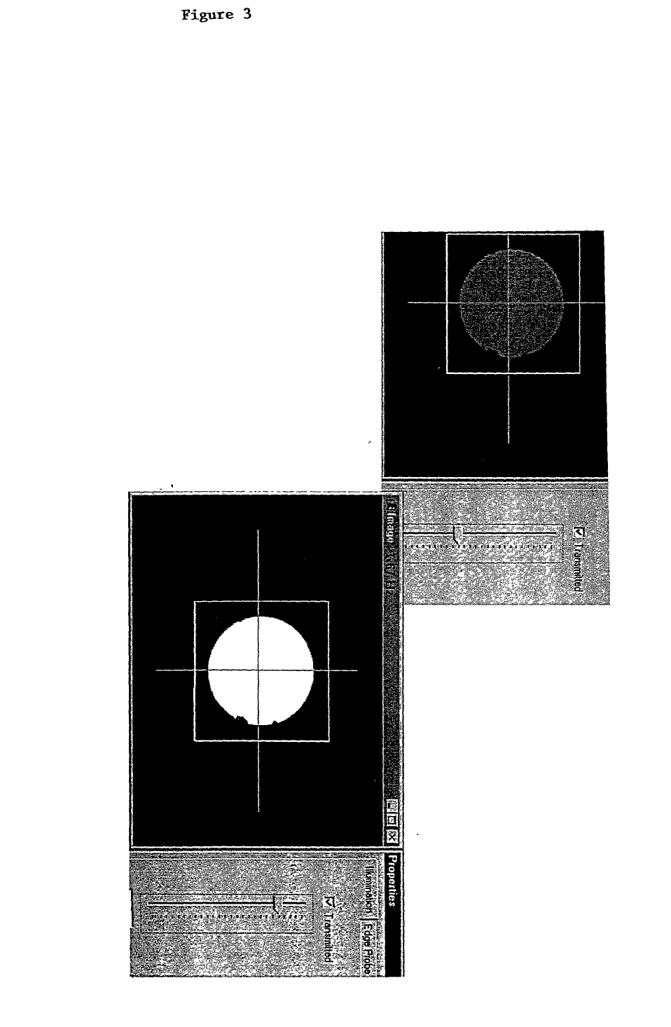

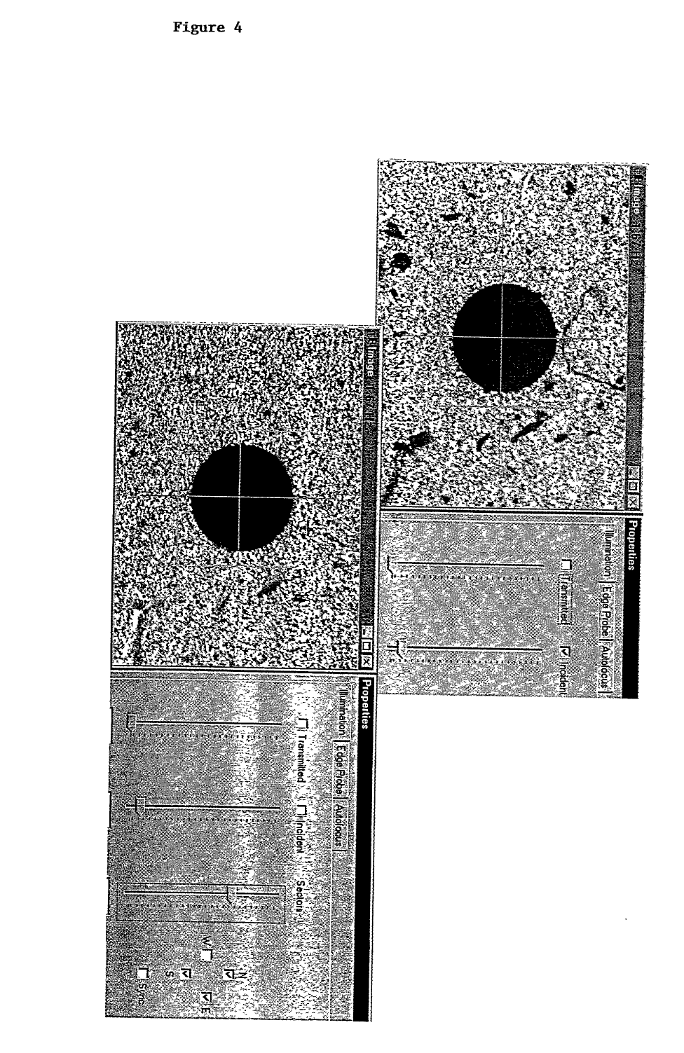

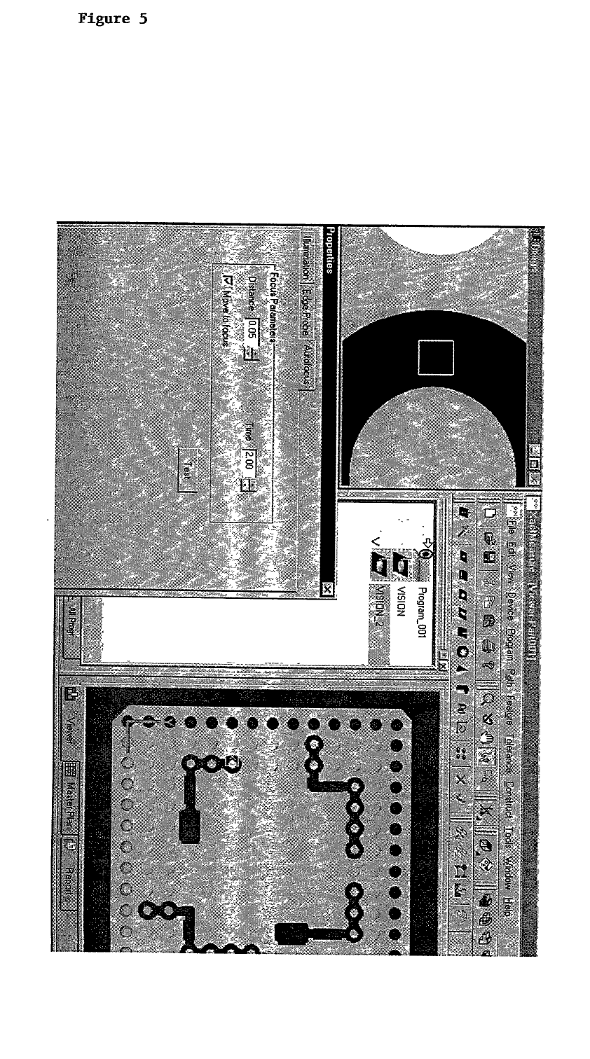

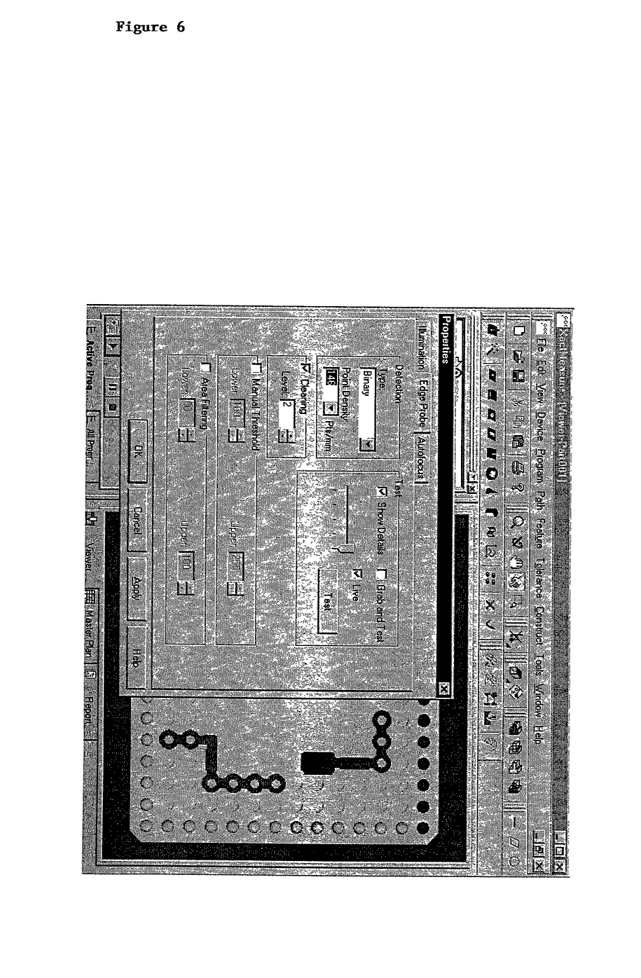

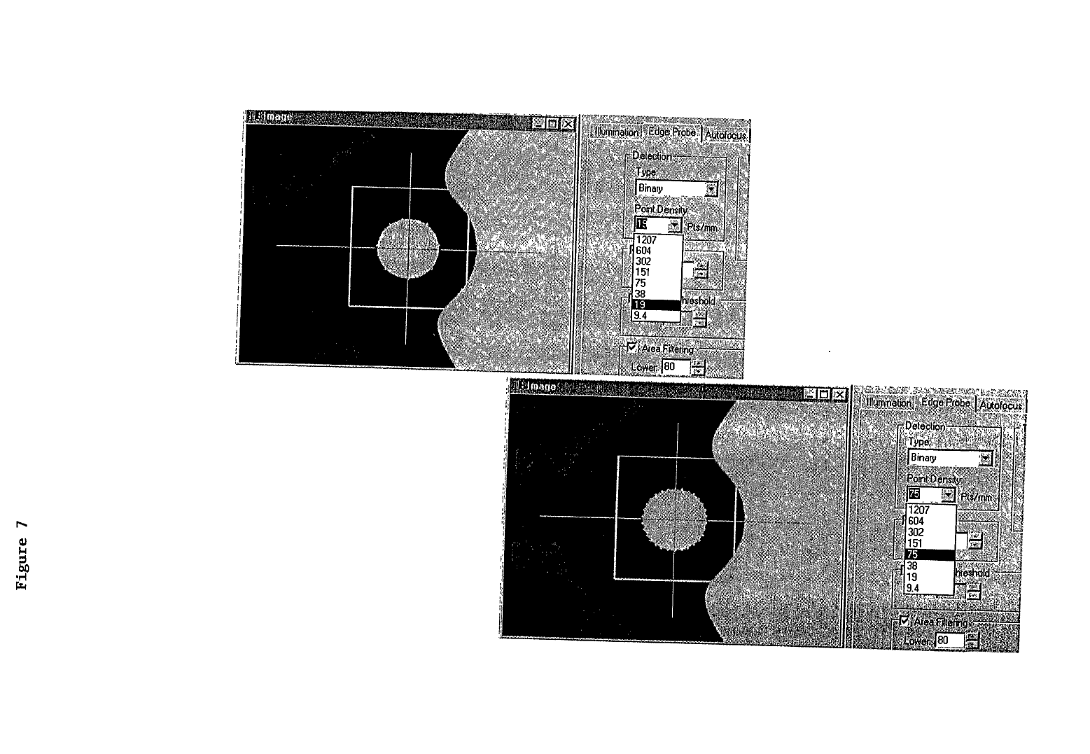

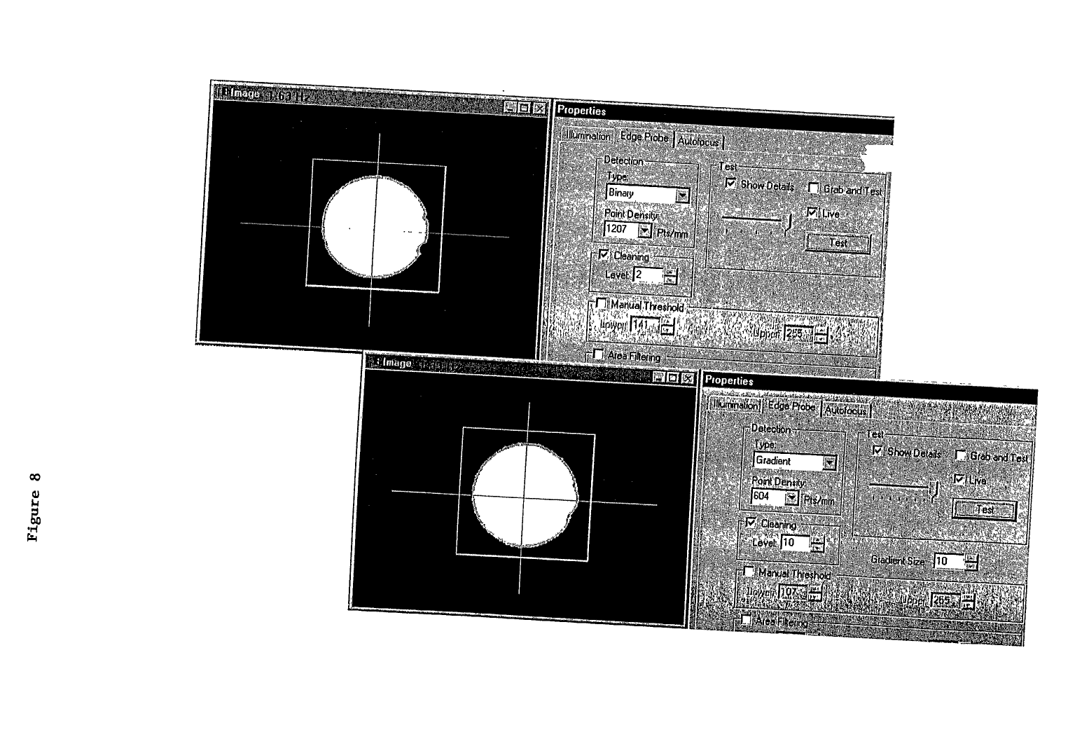

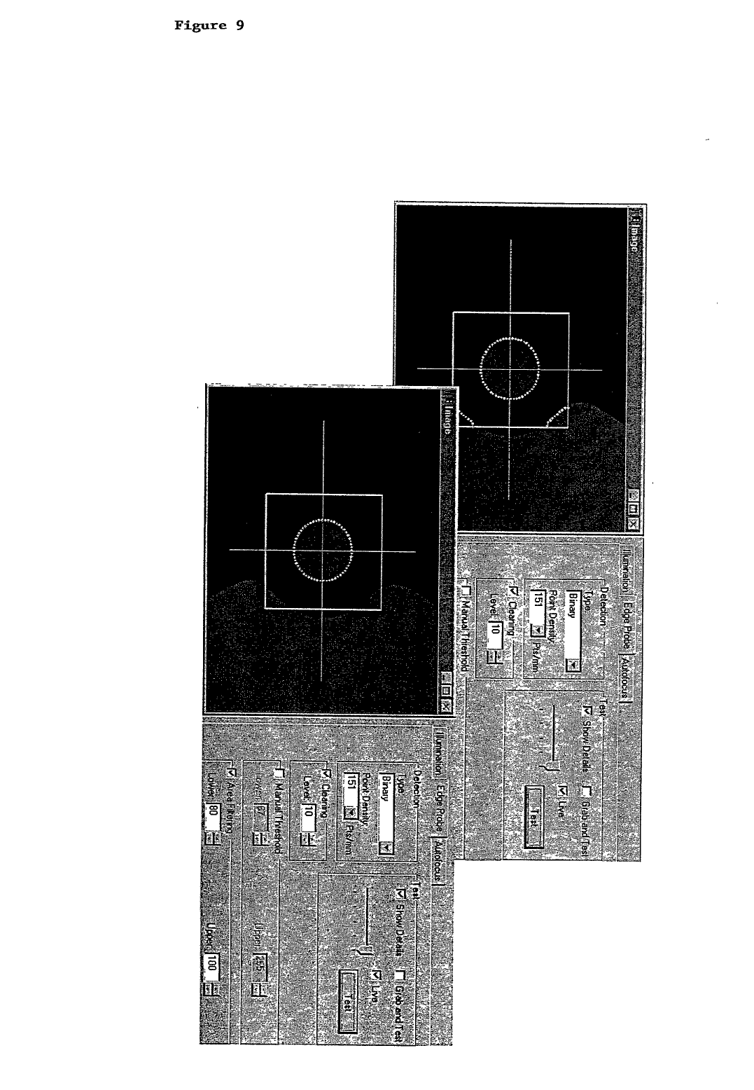

In the screen shot of FIGS. 3 and 4, a view into a hole in the part has been selected. The operator adjusts the lighting magnitude and type using conventional graphical controls to obtain an image which is acceptable for further processing. FIG. 3 shows a transmission service illuminating the part from behind the hole. FIG. 4 shows an incident source and an oblique source illuminating the part surface. As shown in FIGS. 5 and 6, other parameters such as autofocus parameter (FIG. 5) and edge detection parameters (FIG. 6) are then selected. The density of points to be identified by the edge detection is set, as shown in FIG. 7, so as to define each edge to be measured with a desired resolution. The edge detection parameters include various filtering options, as shown in FIGS. 8 and 9. FIG. 8 shows the result of applying an edge cleaning filter which smoothes the edge, removing anomalous bumps or nicks, while FIG. 9 shows the effect of an area filter which removes from consideration areas smaller than a specified value.

Next, a process of developing a measurement program for a portion of the part illustrated in FIG. 2 is discussed. The portion of the part to be measured is the feature at the lower left.

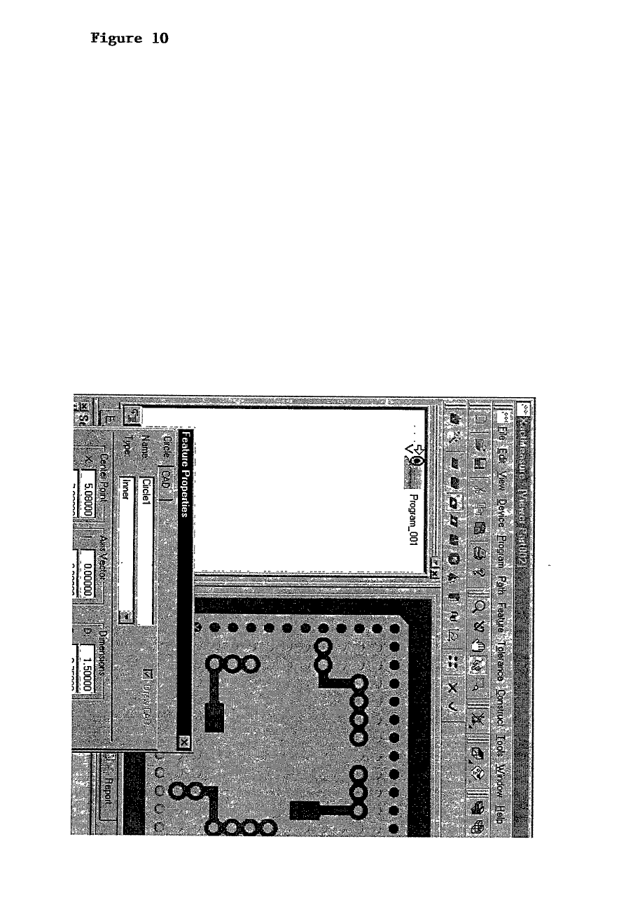

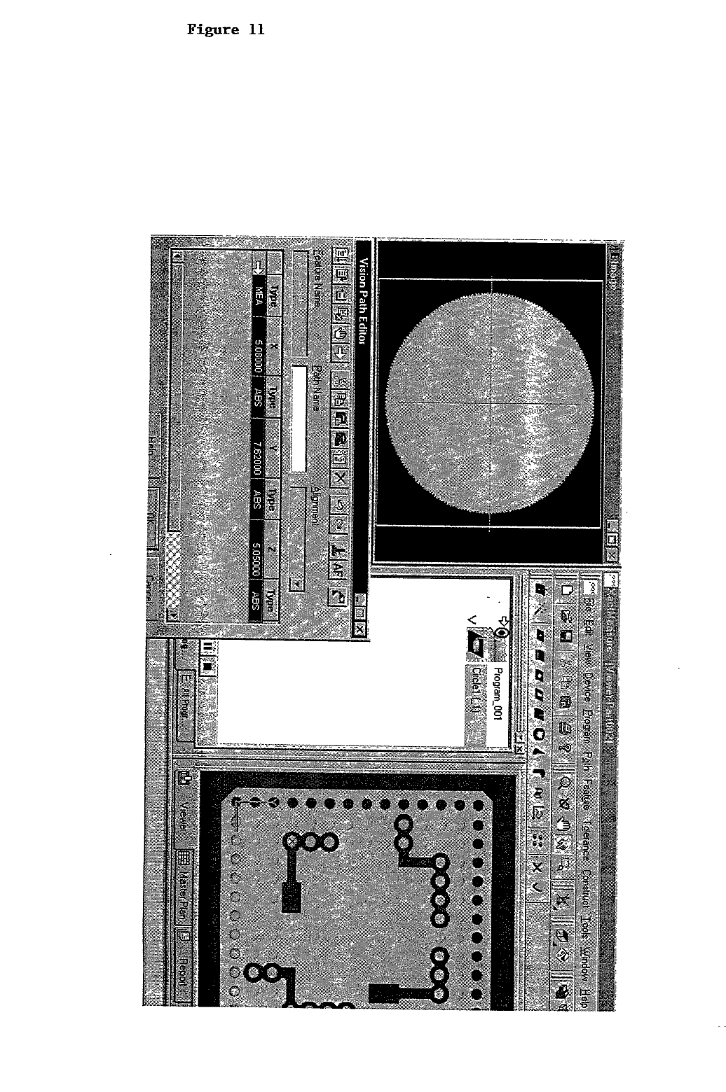

First, a circle measurement step is inserted into the program being developed, as shown in FIG. 10. The path of the measurement is then defined as shown in FIG. 11.

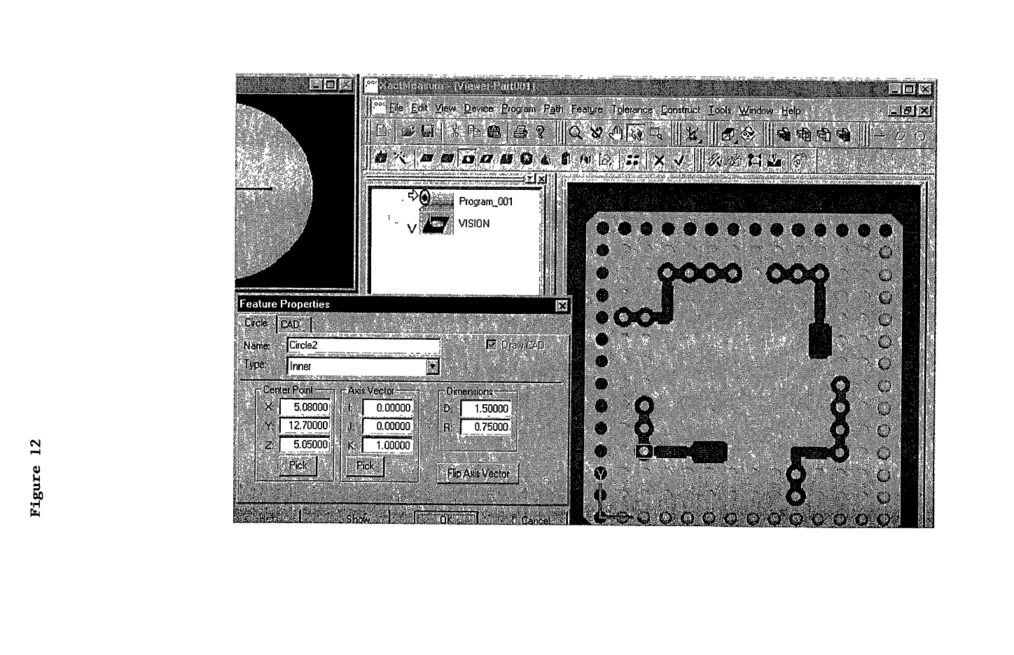

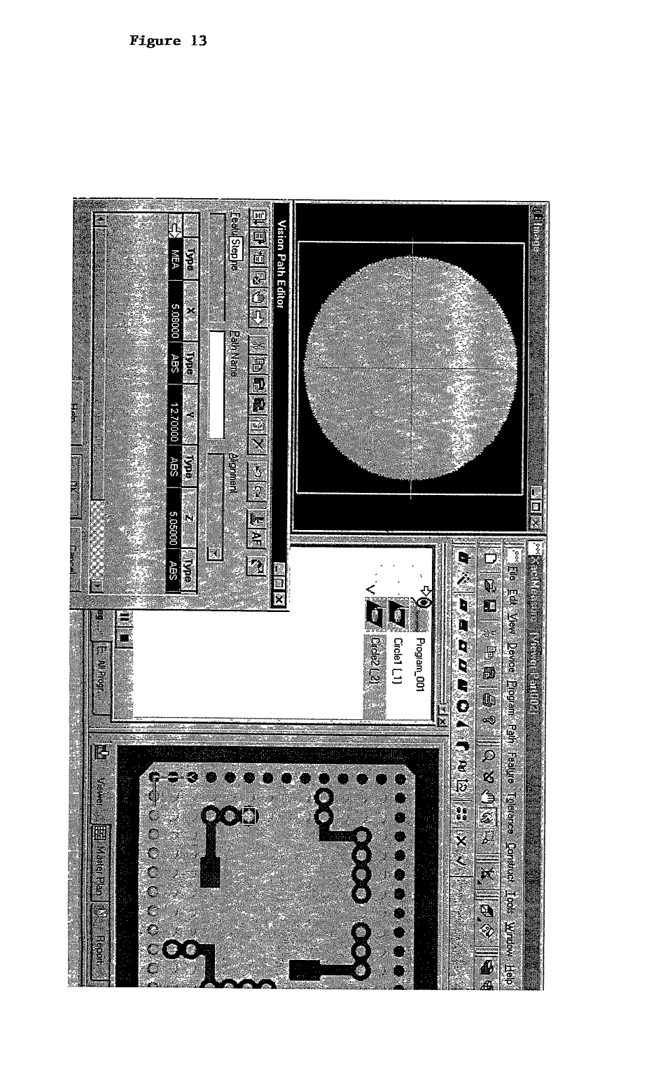

Next, as shown in FIGS. 12 and 13, a second circle measurement is defined.

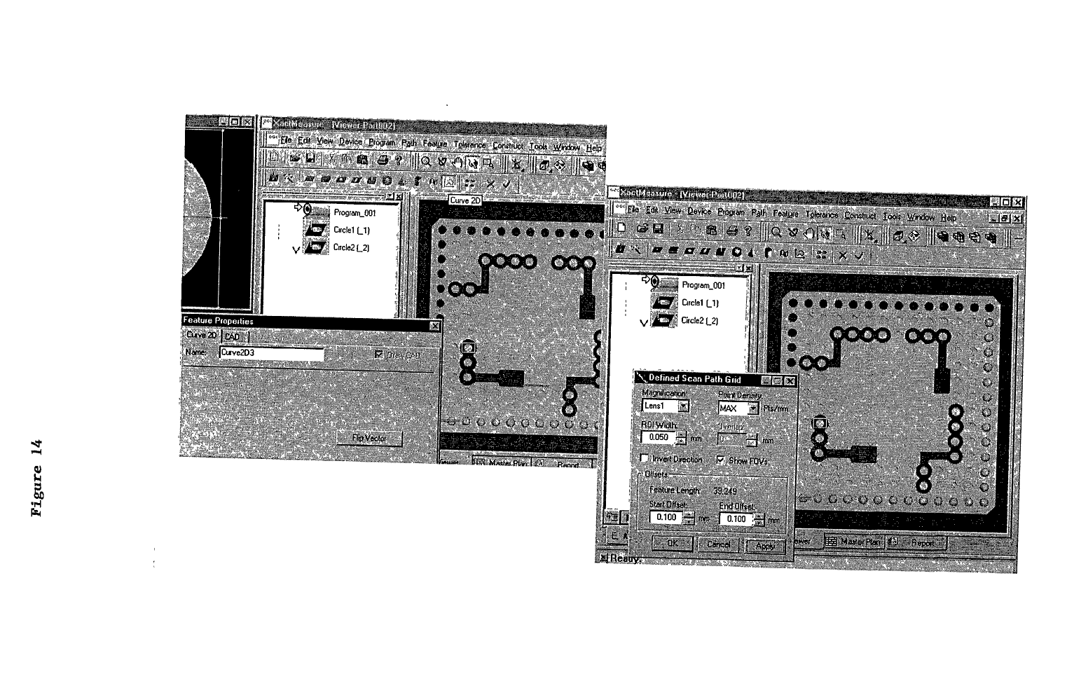

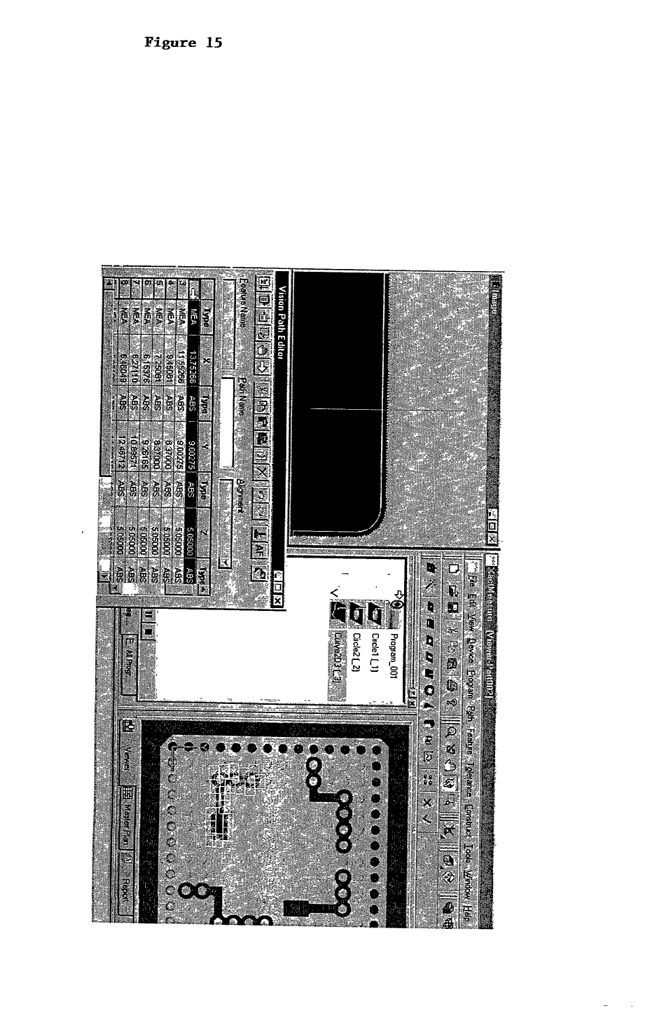

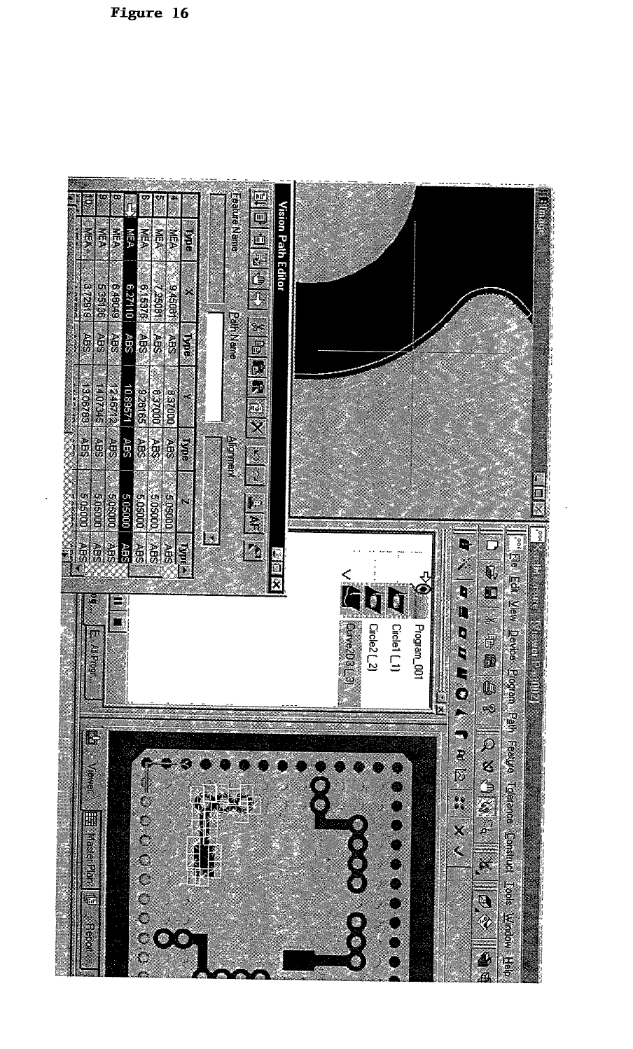

The main outline of the feature is a compound, two-dimensional (2D) curve. A special 2D curve measurement is now set up as shown in FIGS. 14-16. The curve path is automatically generated, according to parameters set as indicated in FIG. 14. For example, a magnification, point density and width of the region of interest (ROI) are selected, along with a starting point. After the path is generated, the fields of view needed to follow the path are depicted, as shown in FIG. 15. The generated path and fields of view ca then be checked for proper coverage of the feature. The path can be stepped through, as shown in FIG. 16, and the image produced at each point along the path checked.

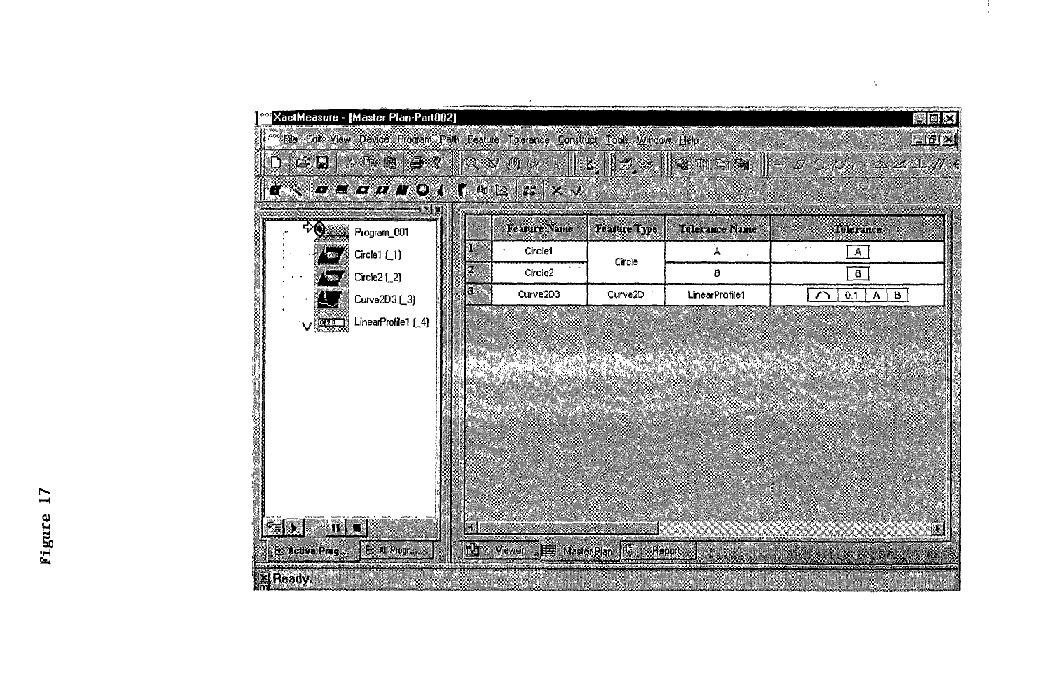

The system lends itself to standard measurement features, such as tolerancing. Each feature to be measured can be toleranced, as shown in FIG. 17, using industry standard forms.

The present invention has now been described in connection with a number of specific embodiments thereof. However, numerous modifications, which are contemplated as falling within the scope of the present invention, should now be apparent to those skilled in the art. Therefore, it is intended that the scope of the present invention be limited only by the scope of the claims appended hereto.

What is claimed is:

1. Apparatus for simulating the measurement of a part using a visual measurement system, the apparatus comprising:
a computer executing a software program which receives a digital model of a part, and renders an image of the model of the part, the image rendered under conditions simulating a measurement system, and which evaluates the image to produce a value representative of a physical characteristic of the part.

2. A method of simulating measurement of a physical part using a computer model of the physical part, comprising:
launching measurement software;
simulating a physical measurement system;
manipulating the simulated measurement system to produce a virtual observation of the computer model; and
analyzing the virtual observation to produce the simulated measurement.

3. A software product including a machine readable medium on which is encoded a sequenced instructions which when executed cause an apparatus to perform steps of:
launching measurement software;
simulating a physical measurement system;
manipulating the simulated measurement system to produce a virtual observation of the computer model; and
analyzing the virtual observation to produce the simulated measurement.
